(19) United States
(12) Patent Application Publication
(10) Pub. No.: US 2021/0152750 A1
(43) Pub. Date: May 20, 2021

(54) INFORMATION PROCESSING APPARATUS AND METHOD FOR CONTROLLING THE SAME

(71) Applicant: CANON KABUSHIKI KAISHA, Tokyo (JP)

(72) Inventor: Nobushige Wakamatsu, Tokyo (JP)

(21) Appl. No.: 17/158,622

(22) Filed: Jan. 26, 2021

Related U.S. Application Data
(63) Continuation of application No. PCT/JP2019/028929, filed on Jul. 24, 2019.

(30) Foreign Application Priority Data
Jul. 31, 2018 (JP) 2018-143938

(51) Int. Cl. H04N 5/247; H04N 5/232; H04N 7/18; H04N 5/225; G06K 9/20

(52) U.S. Cl. CPC H04N 5/247; H04N 5/23296; H04N 7/181; H04N 5/23216; H04N 5/2259; G06K 9/2054; H04N 5/23203; H04N 7/188

(57) ABSTRACT

Imaging coverages of a plurality of imaging apparatuses are calculated based on position information about a position of each of the plurality of imaging apparatuses, azimuth and angle information about the plurality of imaging apparatuses, and imaging area information about the plurality of imaging apparatuses. A notification of an area capable of comprehensive imaging and an area not capable of comprehensive imaging is made based on the imaging coverages.

### CROSS-REFERENCE TO RELATED APPLICATIONS

This application is a Continuation of International Patent Application No. PCT/JP2019/028929, filed Jul. 24, 2019, which claims the benefit of Japanese Patent Application No. 2018-143938, filed Jul. 31, 2018, both of which are hereby incorporated by reference herein in their entirety.

### BACKGROUND OF THE INVENTION

### Field of the Invention

The present invention relates to an information processing apparatus and a method for controlling the same.

### Background Art

Nowadays, a large number of imaging apparatuses directed to various positions and at various angles are sometimes to be installed to capture video images from various viewpoints. While video images of imaging apparatuses at user-desired viewpoints are to be obtained from among the video images of the plurality of imaging apparatuses, it is difficult to appropriately store only the video images desired by the user among those of the large number of imaging apparatuses.

Patent Literature 1 discusses a method where imaging apparatuses each have gazing point information and their position information and direction information, and video images captured by the imaging apparatuses are selected based on user's attribute information.

Techniques about an imaging apparatus having pan and tilt functions and a function of automatically keeping track of a specific object have also been discussed. For example, Patent Literature 2 discusses a control method for determining differences between the center coordinates of a monitor and the position coordinates of an object and driving the pan and tilt angles to move the object to the screen center to output an image in which the object is present at the center of the monitor screen.

In a system that captures images from a plurality of viewpoints by using a plurality of imaging apparatuses, the exact installation positions of the imaging apparatuses and the optical axis directions and the angles of views of the imaging apparatuses are typically set before use. The imaging apparatuses can cooperatively perform framing through pan, tilt, and zoom driving based on the installation positions and the directions of the imaging apparatuses, whereas it is difficult to easily install and calibrate the plurality of imaging apparatuses. If the user carelessly installs the imaging apparatuses, the user has had difficulty in easily checking a range where images can be captured from a plurality of viewpoints or a range where imaging from a plurality of viewpoints is difficult.

The present invention is directed to providing an information processing apparatus that facilitates checking an imaging area in operating a plurality of imaging apparatuses in a cooperative manner and a method for controlling the same.

### CITATION LIST

### Patent Literature

PTL 1: Japanese Patent Laid-Open No. 2014-215828

PTL 2: Japanese Patent Laid-Open No. 5-28923

### SUMMARY OF THE INVENTION

An information processing apparatus includes a storage unit configured to store position information about a position of each of a plurality of imaging apparatuses, an obtaining unit configured to obtain azimuths and angles of the plurality of imaging apparatuses, a setting unit configured to set an imaging area of the plurality of imaging apparatuses, and a notification unit configured to make a notification of an area to be comprehensively imaged and an area to not be comprehensively imaged based on the position information stored in the storage unit, information obtained by the obtaining unit, and information about the imaging area set by the setting unit.

Further features of the present invention will become apparent from the following description of exemplary embodiments with reference to the attached drawings.

### BRIEF DESCRIPTION OF THE DRAWINGS

FIG. 1A is a diagram schematically illustrating an imaging apparatus according to an exemplary embodiment.

FIG. 1B is a diagram schematically illustrating an imaging apparatus according to the exemplary embodiment.

FIG. 2 is a diagram illustrating a configuration of the imaging apparatus according to the present exemplary embodiment.

FIG. 3 is a diagram illustrating a system configuration of a control system including a plurality of imaging apparatuses and an external apparatus according to the present exemplary embodiment.

FIG. 4 is a diagram illustrating a configuration of the external apparatus according to the present exemplary embodiment.

FIG. 5A is a diagram for illustrating a remote control setting mode of an application according to the present exemplary embodiment.

FIG. 5B is a diagram for illustrating a remote control setting mode of an application according to the present exemplary embodiment.

FIG. 5C is a diagram for illustrating a remote control setting mode of an application according to the present exemplary embodiment.

FIG. 5D is a diagram for illustrating a remote control setting mode of an application according to the present exemplary embodiment.

FIG. 6 is a diagram illustrating a system configuration of a control system including a plurality of imaging apparatuses and a smart device according to the present exemplary embodiment.

FIG. 7 is a diagram for illustrating a method for setting imaging apparatuses according to the present exemplary embodiment.

FIG. 8 is a diagram for illustrating the application according to the present exemplary embodiment.

FIG. 9A is a diagram for illustrating imaging area setting by the application according to the present exemplary embodiment.

FIG. 9B is a diagram for illustrating imaging area setting by the application according to the present exemplary embodiment.

FIG. 10A is a diagram for illustrating imaging area setting by the application according to the present exemplary embodiment.

FIG. 10B is a diagram for illustrating imaging area setting by the application according to the present exemplary embodiment.

FIG. 10C is a diagram for illustrating imaging area setting by the application according to the present exemplary embodiment.

FIG. 10D is a diagram for illustrating imaging area setting by the application according to the present exemplary embodiment.

FIG. 11 is a diagram for illustrating imaging area setting by the application according to the present exemplary embodiment.

FIG. 12A is a diagram for illustrating a display example of the application according to the present exemplary embodiment in an imaging area check mode.

FIG. 12B is a diagram for illustrating a display example of the application according to the present exemplary embodiment in an imaging area check mode.

FIG. 12C is a diagram for illustrating a display example of the application according to the present exemplary embodiment in an imaging area check mode.

FIG. 13A is a diagram for illustrating a display example of the application according to the present exemplary embodiment in an overall imaging area setting mode.

FIG. 13B is a diagram for illustrating a display example of the application according to the present exemplary embodiment in an overall imaging area setting mode.

FIG. 13C is a diagram for illustrating a display example of the application according to the present exemplary embodiment in an overall imaging area setting mode.

FIG. 13D is a diagram for illustrating a display example of the application according to the present exemplary embodiment in an overall imaging area setting mode.

FIG. 13E is a diagram for illustrating a display example of the application according to the present exemplary embodiment in an overall imaging area setting mode.

FIG. 13F is a diagram for illustrating a display example of the application according to the present exemplary embodiment in an overall imaging area setting mode.

FIG. 14A is a diagram for illustrating a display example of the application according to the present exemplary embodiment in an individual imaging area setting mode.

FIG. 14B is a diagram for illustrating a display example of the application according to the present exemplary embodiment in an individual imaging area setting mode.

FIG. 14C is a diagram for illustrating a display example of the application according to the present exemplary embodiment in an individual imaging area setting mode.

FIG. 14D is a diagram for illustrating a display example of the application according to the present exemplary embodiment in an individual imaging area setting mode.

FIG. 14E is a diagram for illustrating a display example of the application according to the present exemplary embodiment in an individual imaging area setting mode.

FIG. 14F is a diagram for illustrating a display example of the application according to the present exemplary embodiment in an individual imaging area setting mode.

FIG. 15 is a flowchart for illustrating imaging mode processing according to the present exemplary embodiment.

FIG. 16A is a diagram for illustrating area division in a captured image according to the present exemplary embodiment.

FIG. 16B is a diagram for illustrating area division in a captured image according to the present exemplary embodiment.

FIG. 16C is a diagram for illustrating area division in a captured image according to the present exemplary embodiment.

FIG. 16D is a diagram for illustrating area division in a captured image according to the present exemplary embodiment.

### DESCRIPTION OF THE EMBODIMENTS

Exemplary embodiments of the present invention will be described in detail below with reference to the attached drawings.

### Configuration of Imaging Apparatus

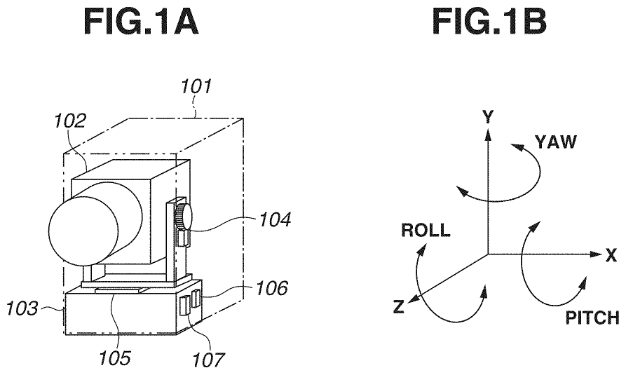

FIG. 1A is a diagram schematically illustrating an imaging apparatus used in a control system of a plurality of cooperative imaging apparatuses according to a first exemplary embodiment.

An imaging apparatus 101 illustrated in FIG. 1A includes an operation member capable of a power switch operation (hereinafter referred to as a power button, whereas operations such as a tap, flick, and swipe on a touch panel may be used instead). A lens barrel 102 is a casing including an imaging lens group and an image sensor for capturing an image. The lens barrel 102 is equipped with rotation mechanisms that are attached to the imaging apparatus 101 and can drive the lens barrel 102 to rotate with respect to a fixing unit 103. A tilt rotation unit 104 is a motor drive mechanism that can rotate the lens barrel 102 in a pitch direction illustrated in FIG. 1B. A pan rotation unit 105 is a motor drive mechanism that can rotate the lens barrel 102 in a yaw direction. The lens barrel 102 can thus rotate about one or more axial directions. FIG. 1B illustrates the definitions of the axes at the position of the fixing unit 103. An angular velocity meter 106 and an acceleration meter 107 are both mounted on the fixing unit 103 of the imaging apparatus 101. Vibrations of the imaging apparatus 101 are detected based on the angular velocity meter 106 and the acceleration meter 107, and the tilt rotation unit 104 and the pan rotation unit 105 are driven to rotate based on the detected vibration angles. Thus, the imaging apparatus 101 is configured to correct shakes and tilts of the lens barrel 102 that is a movable unit.

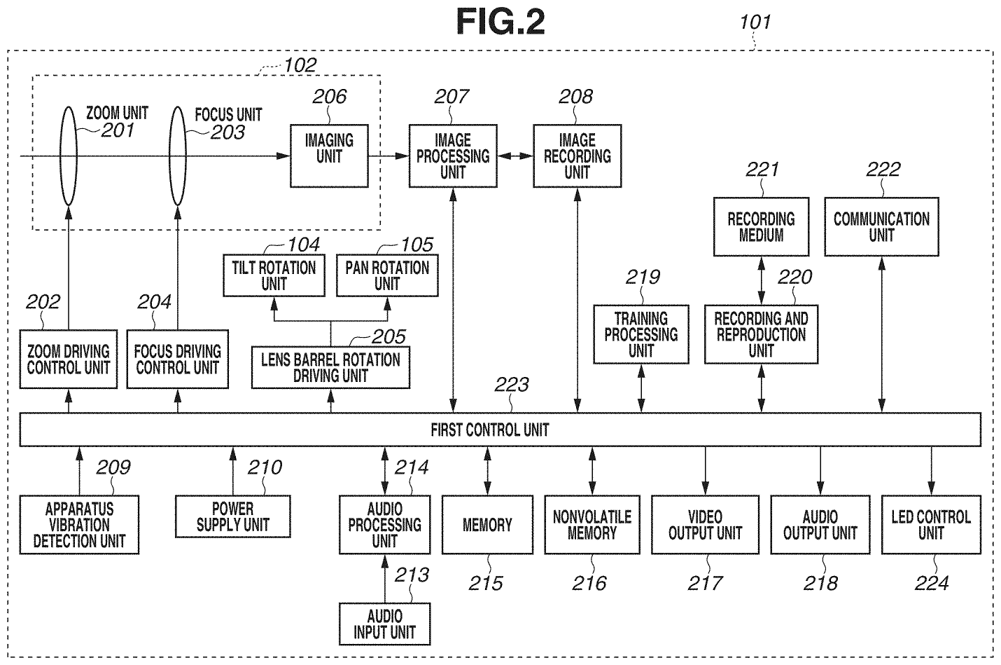

FIG. 2 is a block diagram illustrating a configuration of the imaging apparatus 101 according to the present exemplary embodiment.

In FIG. 2, a first control unit 223 includes a processor (such as a central processing unit (CPU), a graphics processing unit (GPU), a microprocessor, and a microprocessing unit (MPU)) and a memory (such as a dynamic random access memory (DRAM) and a static random access memory (SRAM)). Such components perform various types of processing to control various blocks of the imaging apparatus 101, and control data transfer between the blocks. A nonvolatile memory (electrically erasable programmable read-only memory (EEPROM)) 216 is an electrically erasable and recordable memory, and stores operating constants and programs intended for the first control unit 223.

In FIG. 2, a zoom unit 201 includes a variable power zoom lens. A zoom driving control unit 202 controls driving of the zoom unit 201. A focus unit 203 includes a lens for making a focus adjustment. A focus driving control unit 204 controls driving of the focus unit 203.

An imaging unit 206 includes an image sensor that receives light incident through the lens groups and outputs information about charges corresponding to the amount of the light as analog image data to an image processing unit 207. The image processing unit 207 performs analog-to-digital (A/D) conversion on the analog image data, applies image processing to the resulting digital image data, and outputs the image-processed digital image data. Examples of the image processing include distortion correction, white balance adjustment, and color interpolation processing. An image recording unit 208 converts the digital image data output from the image processing unit 207 into a recording format, such as a Joint Photographic Experts Group (JPEG) format, and transmits the converted digital image data to a memory 215 and/or a video output unit 217 to be described below.

A lens barrel rotation driving unit 205 drives the tilt rotation unit 104 and the pan rotation unit 105 to drive the lens barrel 102 in the tilt and pan directions.

An apparatus vibration detection unit 209 includes the angular velocity meter (gyro sensor) 106 and the acceleration meter (acceleration sensor) 107, for example. The angular velocity meter 106 detects the angular velocity of the imaging apparatus 101 about the three axial directions. The acceleration meter 107 detects the accelerations of the imaging apparatus 101 about the three axial directions. The apparatus vibration detection unit 209 calculates the rotation angles of the imaging apparatus 101 and the amounts of shift of the imaging apparatus 101 based on the detected signals.

An audio input unit 213 obtains an audio signal around the imaging apparatus 101 from a microphone mounted on the imaging apparatus 101, performs A/D conversion, and transmits the resulting digital audio signal to an audio processing unit 214. The audio processing unit 214 performs audio-related processing, such as optimization processing, on the input digital audio signal. The first control unit 223 transmits the audio signal processed by the audio processing unit 214 to the memory 215. The memory 215 temporarily stores the image signal and the audio signal obtained by the image processing unit 207 and the audio processing unit 214.

The image processing unit 207 and the audio processing unit 214 read the image signal and the audio signal temporarily stored in the memory 215, and encode the image signal and the audio signal to generate a compressed image signal and a compressed audio signal. The first control unit 223 transmits the compressed image signal and the compressed audio signal to a recording and reproduction unit 220.

The recording and reproduction unit 220 records the compressed image signal and the compressed audio signal generated by the image processing unit 207 and the audio processing unit 214, and other imaging-related control data, on a recording medium 221. If the audio signal is not compression coded, the first control unit 223 transmits the audio signal generated by the audio processing unit 214 and the compressed image signal generated by the image processing unit 207 to the recording and reproduction unit 220 so that the audio signal and the compressed image signal are recorded on the recording medium 221.

The recording medium 221 may be one built in the imaging apparatus 101 or a removable one. The recording medium 221 can record various types of data, including the compressed image signal, the compressed audio signal, and the audio signal generated by the imaging apparatus 101. A medium having a larger capacity than the nonvolatile memory 216 is typically used as the recording medium 221. Examples of the recording medium 211 may include all kinds of recording media, such as a hard disk, an optical disk, a magneto-optic disk, a compact disc recordable (CD-R), a digital versatile disc recordable (DVD-R), a magnetic tape, a nonvolatile semiconductor memory, and a flash memory.

The recording and reproduction unit 220 reads (reproduces) compressed image signals, compressed audio signals, audio signals, various types of data, and/or programs recorded on the recording medium 221. The first control unit 223 transmits the read compressed image and audio signals to the image processing unit 207 and the audio processing unit 214. The image processing unit 207 and the audio processing unit 214 temporarily store the compressed image and audio signals in the memory 215, decode the signals by a predetermined procedure, and transmit the decoded signals to the video output unit 217 and an audio output unit 218.

The audio input unit 213 includes a plurality of microphones mounted on the imaging apparatus 101. The audio processing unit 214 can detect the direction of sound on a plane where the plurality of microphones is located. The direction of sound is used for a search and automatic imaging to be described below. The audio processing unit 214 also detects specific voice commands The audio processing unit 214 may be configured so that the user can register specific sound in the imaging apparatus 101 as a voice command aside from several commands registered in advance. The audio processing unit 214 also performs sound scene recognition. The sound scene recognition includes making a sound scene determination by using a network trained through machine learning based on a large amount of audio data in advance. For example, the audio processing unit 214 includes a network for detecting specific scenes, such as “cheers arising”, “hands clapping”, and “voice uttered”. The audio processing unit 214 is configured to output a detection trigger signal to the first control unit 223 in response to a specific sound scene or specific voice command being detected.

A power supply unit 210 supplies power for operating the first control unit 223. The audio output unit 218 outputs a preset sound pattern from a speaker built in the imaging apparatus 101 during imaging, for example.

A light-emitting diode (LED) control unit 224 controls a preset on-off pattern of an LED mounted on the imaging apparatus 101 during imaging, for example.

The video output unit 217 includes a video output terminal, for example. The video output unit 217 transmits an image signal for displaying a video image on an external display connected. The audio output unit 218 and the video output unit 217 may be configured as an integrated terminal, such as a High-Definition Multimedia Interface (HDMI (registered trademark)) terminal.

A training processing unit 219 trains a neural network to the user's preferences by using a machine learning algorithm.

A communication unit 222 performs communication between the imaging apparatus 101 and an external apparatus. For example, the communication unit 222 transmits and receives data, such as an audio signal, an image signal, a compressed audio signal, and a compressed image signal. The communication unit 222 also receives imaging-related control signals, such as imaging start and end commands and pan, tilt, and zoom driving control signals, and drives the imaging apparatus 101 based on instructions from an external apparatus capable of mutual communication with the imaging apparatus 101. The communication unit 222 also transmits and receives information, such as various training-related parameters to be processed by the training processing unit 219 between the imaging apparatus 101 and the external apparatus. Examples of the communication unit 222 include an infrared communication module, a Bluetooth® communication module, a wireless local area network (LAN) communication module, and a Wireless Universal Serial Bus (USB) communication module, and a wireless communication module, such as a Global Positioning System (GPS) receiver.

### Configuration of Control System Including Plurality of Cooperative Imaging Apparatuses

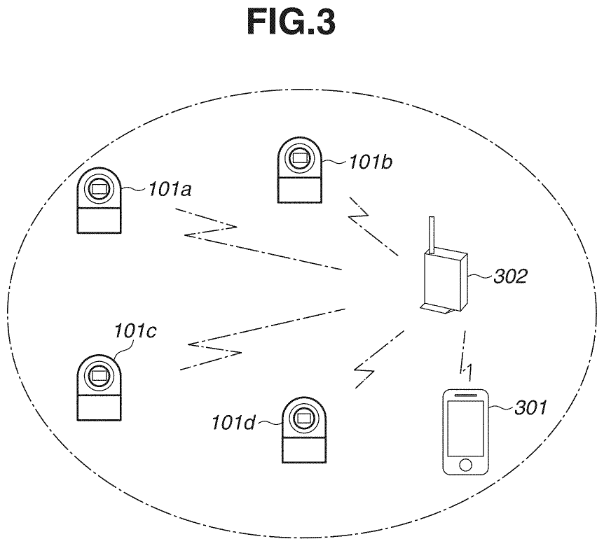

FIG. 3 illustrates an example of a control system including a plurality of cooperative imaging apparatuses.

Imaging apparatuses 101a, 101b, 101c, and 101d can communicate wirelessly with a controller unit (smart device) 301 having a communication function. The imaging apparatuses 101a, 101b, 101c, and 101d can receive operation instructions transmitted to individual imaging apparatuses 101a, 101b, 101c, and 101d from the controller unit 301 (smart device) and transmit control information about the respective imaging apparatuses 101a, 101b, 101c, and 101d to the controller unit 301. In FIG. 3, the imaging apparatuses 101a, 101b, 101c, and 101d and the smart device 301 each connect to an access point 302, and communicate via the access point 302 to transfer information.

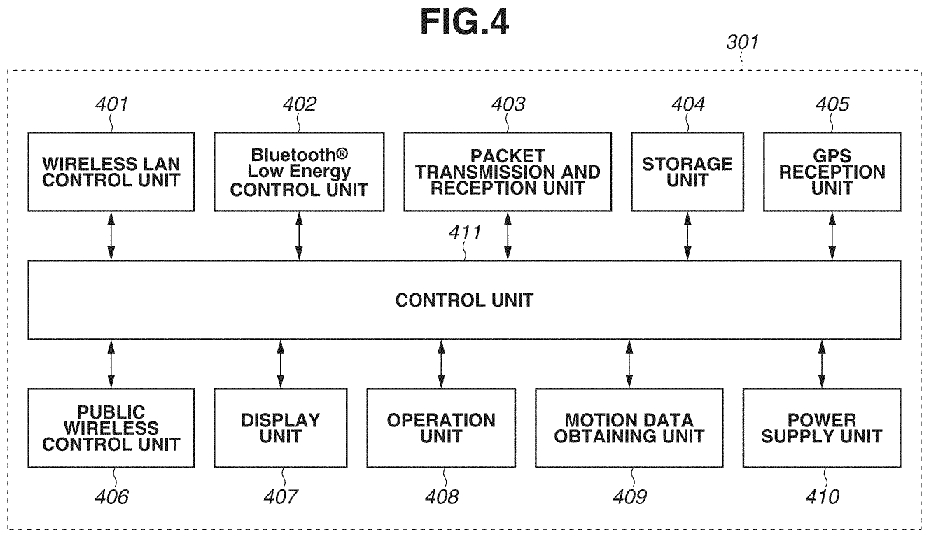

A configuration of the smart device 301 including a wireless LAN communication module will be described with reference to FIG. 4.

The smart device 301 is an information processing apparatus including, for example, a wireless LAN control unit 401 intended for a wireless LAN, a Bluetooth® Low Energy control unit 402 intended for Bluetooth® Low Energy, and a public wireless control unit 406 intended for public wireless communication. The smart device 301 further includes a packet transmission and reception unit 403. The wireless LAN control unit 401 performs wireless LAN radio frequency (RF) control, communication processing, and protocol processing related to a driver for performing various types of control on wireless LAN communication compliant with the Institute of Electrical and Electronics Engineers (IEEE) 802.11 standard series and the wireless LAN communication. The Bluetooth® Low Energy control unit 402 performs Bluetooth® Low Energy RF control, communication processing, and protocol processing related to a driver for performing various types of control on Bluetooth® Low Energy communication and the Bluetooth® Low Energy communication. The public wireless control unit 406 performs public wireless communication RF control, communication processing, and protocol processing related to a driver for performing various types of control on public wireless communication and the public wireless communication. Examples of the public wireless communication include ones compliant with the International Multimedia Telecommunications (IMT) standard and the Long-Term Evolution (LTE) standard. The packet transmission and reception unit 403 performs processing for at least either transmitting or receiving packets related to the wireless LAN and the Bluetooth® Low Energy and public wireless communications. In this example, the smart device 301 is described to at least either transmit or receive packets during communication. However, communication modes other than packet switching, like circuit switching, may be used.

The smart device 301 further includes, for example, a control unit 411, a storage unit 404, a GPS reception unit 405, a display unit 407, an operation unit 408, a motion data obtaining unit 409, and a power supply unit 410. The control unit 411 controls the entire smart device 301 by executing a control program stored in the storage unit 404, for example. The storage unit 404 stores, for example, the control program to be executed by the control unit 411, and various types of information, such as parameters to be used for communication. Various operations to be described below are implemented by the control unit 411 executing the control program stored in the storage unit 404.

The power supply unit 410 supplies power to the smart device 301. The display unit 407 has a function capable of visually perceptible information output as in a liquid crystal display (LCD) and an LED, and a function capable of sound output as in a speaker, for example. The display unit 407 displays various types of information. Examples of the operation unit 408 include a button for accepting the user's operation on the smart device 301. The display unit 407 and the operation unit 408 may be implemented by a common member, such as a touch panel.

The motion data obtaining unit 409 includes an angular velocity meter (gyro sensor) for detecting the angular velocity of the smart device 301 about three axial directions. The motion data obtaining unit 409 also includes an acceleration meter (acceleration sensor) for detecting the acceleration of the smart device 301 about the three axial directions, and an azimuth meter (azimuth sensor, geomagnetic sensor) for detecting the earth's magnetic field. The control unit 411 calculates the rotation angle and the amount of displacement (the amounts of X-, Y-, and Z-axis movement) of the smart device 301 from the output values of the gyro sensor, the acceleration sensor, and the geomagnetic sensor. The motion data obtaining unit 409 may also include an atmospheric pressure sensor to obtain altitude based on a change in the atmospheric pressure, and use the altitude to detect the amount of displacement.

The GPS reception unit 405 receives GPS signals notified from satellites, analyzes the GPS signals, and estimates the current position (longitude and latitude information) of the smart device 301. Alternatively, the current position of the smart device 301 may be estimated based on information about wireless networks nearby by using the Wi-Fi positioning system (WPS).

The smart device 301 exchanges data with the imaging apparatuses 101 by communication using the wireless LAN control unit 401. For example, the imaging apparatuses 101 and the smart device 301 transmit or receive data such as an audio signal, an image signal, a compressed audio signal, and a compressed image. The smart device 301 receives imaging start information and object detection information from the imaging apparatus 101. The smart device 301 issues imaging and other operation instructions to the imaging apparatus 101.

In the configuration illustrated in FIG. 3, to use the smart device 301 as an imaging apparatus controller, the smart device 301 is configured to serve as a server and transmit and receive information to/from the imaging apparatuses 101a, 101b, 101c, and 101d via the access point 302. However, the smart device 301 may be configured to control the plurality of imaging apparatuses 101a, 101b, 101c, and 101d by other methods.

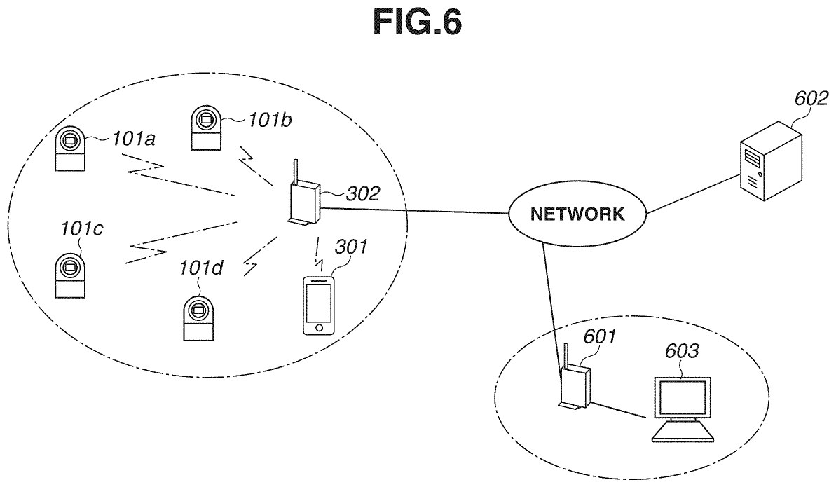

FIG. 6 is a diagram illustrating an example of transfer via a server. The imaging apparatuses 101a, 101b, 101c, and 101d connect wirelessly to a server 602 via the access point 302 and transfer information. A personal computer (PC) 603 connects to the server 602 via an access point 601, and obtains information transferred to the server 602 by the imaging apparatuses 101a, 101b, 101c, and 101d. While in this example the imaging apparatuses 101a, 101b, 101c, and 101d and the PC 603 connect to the server 602 via the different access points 302 and 601, the imaging apparatuses 101a, 101b, 101c, and 101d and the PC 603 may connect to the server 602 via the same access point. The PC 603 and the server 602 are not limited to the wireless connection, and may be connected in a wired manner.

The imaging apparatuses 101a, 101b, 101c, and 101d are not limited to the wireless connection, either, and may be connected in a wired manner. Power over Ethernet (PoE) may be used to supply power to the imaging apparatuses 101a, 101b, 101c, and 101d during operation.

### Imaging Apparatus Layout Setting Method

Take a case where a fixedly-installed plurality of imaging apparatuses 101 performs automatic framing imaging in a cooperative manner by controlling driving of their tilt rotation units 104, pan rotation units 105, and zoom units 201. In such a case, layout information about the imaging apparatuses 101 and angle information about the optical axis directions of the imaging apparatuses 101 are to be found out in advance.

A simple method for obtaining the layout information and angle information about the installed imaging apparatuses 101 will be described.

An application dedicated to controlling a plurality of imaging apparatuses 101 is prepared in the smart device 301. The application is configured so that the user can easily register the installation positions of the imaging apparatuses 101 by using the application, and the plurality of imaging apparatuses 101 can perform framing control in a cooperative manner during imaging.

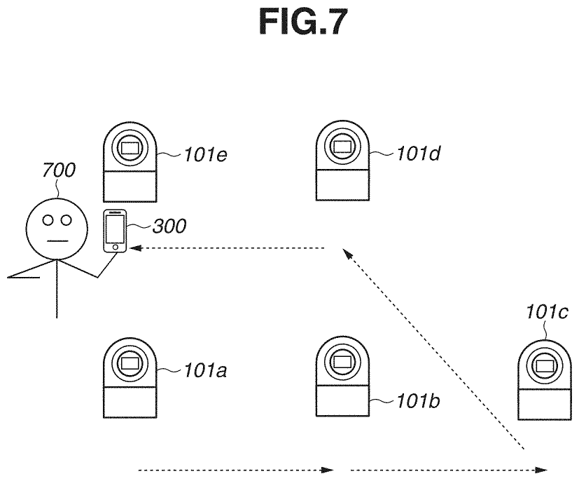

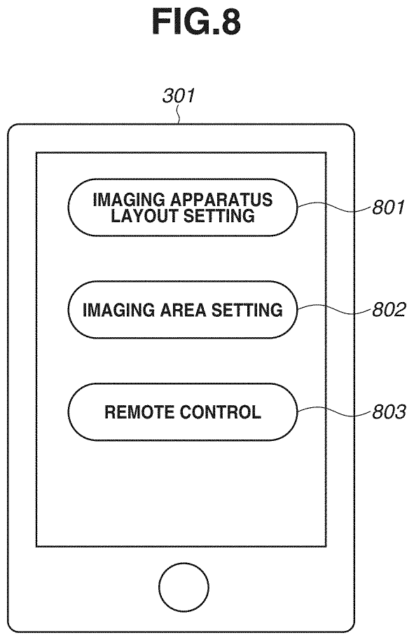

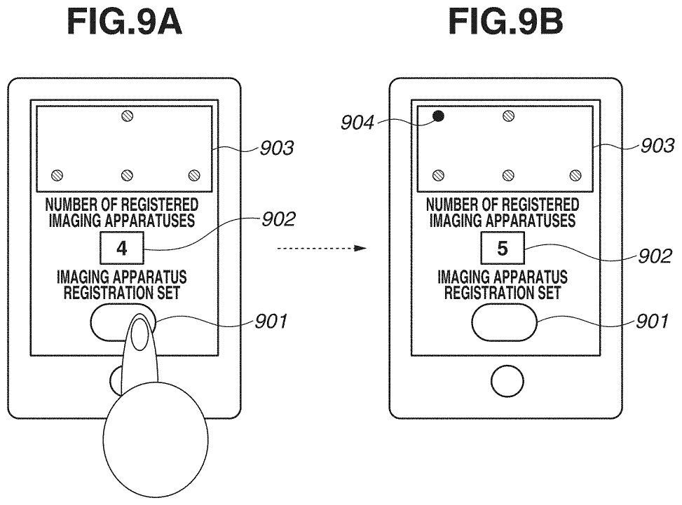

Initially, imaging apparatuses 101a, 101b, 101c, 101d, and 101e are installed at appropriate locations. A user 700 activates the application in the smart device 301. FIG. 8 illustrates a screen example of the activated application. The user 700 taps an imaging apparatus layout setting tab 801, and the screen transitions to an imaging apparatus layout setting screen. FIGS. 9A and 9B illustrates the imaging apparatus layout setting screen. The user 700 moves to a location where the imaging apparatus 101a is installed, brings the smart device 301 as close to the imaging apparatus 101a as possible, and taps an imaging apparatus registration set button 901 to obtain layout information about the imaging apparatus 101a. The user 700 similarly moves to the locations where the imaging apparatuses 101b, 101c, 101d, and 101e are installed, brings the smart device 301 as close to the imaging apparatuses 101b, 101c, 101d, and 101e as possible, and taps the imaging apparatus registration set button 901 to obtain layout information about the imaging apparatuses 101b, 101c, 101d, and 101e (FIG. 7). The installation positions of the registered imaging apparatuses 101 can be checked on a display section 903. The display section 903 displays the installation positions of the imaging apparatuses 101 as seen from above in the direction of gravity by default.

A case where the user 700 moves from the installation location of the imaging apparatus 101d to that of the imaging apparatus 101e and registers the imaging apparatus 101e will be described as an example. When the imaging apparatus 101d is registered, the number of registered imaging apparatuses 101a, 101b, 101c, and 101d is four. A number of registered imaging apparatuses display 902 is thus “4”. If the user 700 moves to the location of the imaging apparatus 101e and taps the imaging apparatus registration set button 901, the number of registered imaging apparatuses display 902 changes from “4” to “5”. The display section 903 additionally displays a new imaging apparatus position 904 as the installation position of the imaging apparatus 101e.

Details of the method for displaying the installation positions of the imaging apparatuses 101 on the display section 903 will be described.

Initially, if the user 700 taps the imaging apparatus registration set button 901 at a position as close to the first imaging apparatus 101a as possible, the XYZ coordinates of that position are registered as (0, 0, 0). The user 700 then moves to the installation position of the next imaging apparatus 101b and registers the imaging apparatus 101b. Here, the installation position of the imaging apparatus 101b is registered by calculating the moving distance from the point where the reference coordinates (0, 0, 0) are initially registered to the point where the imaging apparatus registration set button 901 is next tapped based on the gyro sensor, the acceleration sensor, and the azimuth sensor in the smart device 301. Alternatively, GPS information in the smart device 301 may be used. The imaging apparatuses 101 may include GPS modules. The moving distance may be detected by estimating the current position by trilateration based on differences in the intensity of radio waves received from a plurality of wireless communication apparatuses. The moving distance maybe calculated by using such methods in combination.

The angles of the imaging apparatuses 101 can be calculated from the detection results of the acceleration sensors and azimuth sensors in the imaging apparatuses 101.

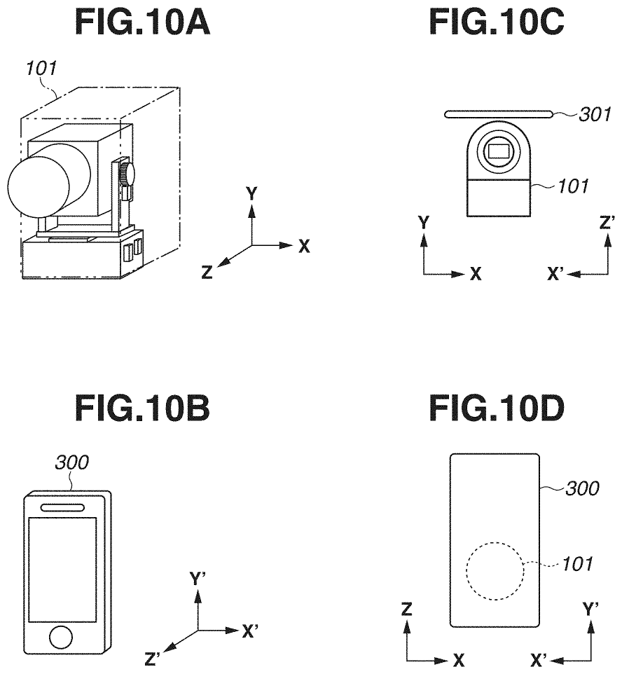

Alternatively, the angles of the imaging apparatuses 101 may be calculated based on the detection results of the acceleration sensor and azimuth sensor in the smart device 301, on the assumption that the user registers each imaging apparatus 101 with the relative angle between the imaging apparatus 101 and the smart device 301 at a fixed value. Suppose that the X, Y, and Z axes of an imaging apparatus 101 are defined as illustrated in FIG. 10A, and the X′, Y′, and Z′ axes of the smart device 301 are defined as illustrated in FIG. 10B. As illustrated in FIGS. 10C and 10D, the user 700 adjusts the Y′ direction of the smart device 301 to the optical axis direction (Z direction) of the imaging apparatus 101 situated at default pan and tilt angles, and taps the imaging apparatus registration set button 901 to set the position and angle of the imaging apparatus 101. In such a manner, the azimuth angle of the imaging apparatus 101 can be obtained by using sensor information in the smart device 301 without equipping the imaging apparatus 101 with an azimuth sensor.

Through the foregoing method, the three axial angles of the imaging apparatus 101 can be calculated.

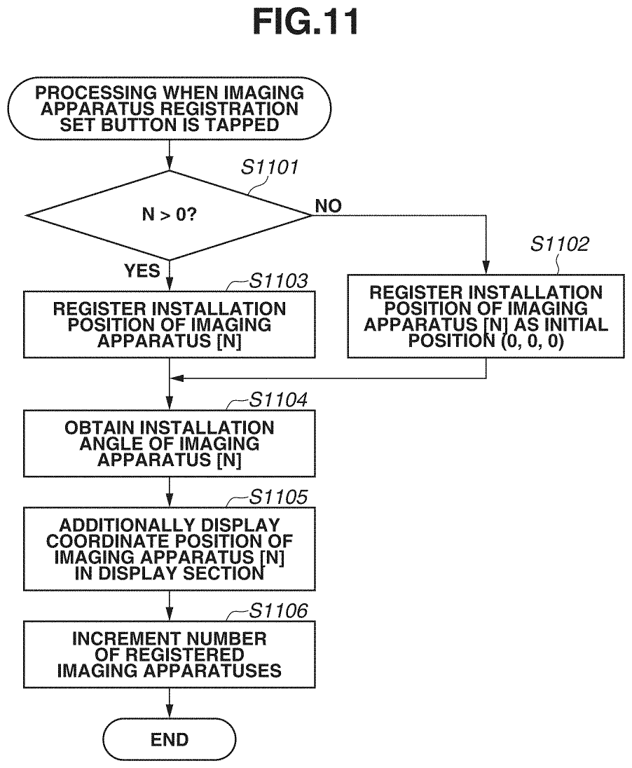

FIG. 11 illustrates a processing procedure of the control unit 411 of the smart device 301 after the imaging apparatus registration set button 901 is tapped.

In step S1101, the control unit 411 determines whether the number of registered imaging apparatuses, N, is greater than 0. If N is 0 (i.e., no imaging apparatus is registered) (NO in step S1101), the processing proceeds to step S1102. In step S1102, the control unit 411 initially registers the installation position of the imaging apparatus [N] (imaging apparatus 101a) as an initial position (0, 0, 0). In step S1101, if N is greater than 0 (YES in step S1101), the processing proceeds to step S1103. In step S1103, to determine the coordinates of the imaging apparatus [N], the control unit 411 calculates the relative position from the installation position of the imaging apparatus [N-1] to the current position. The control unit 411 then registers the installation position of the imaging apparatus [N].

After the processing of step S1102 or S1103, the processing proceeds to step S1104. In step S1104, the control unit 411 obtains the installation angle of the imaging apparatus [N]. The processing proceeds to step S1105. In step S1105, the control unit 411 additionally displays the installation position of the imaging apparatus [N] in the display section 903 displaying the installation positions of imaging apparatuses. The processing proceeds to step S1106. In step S1106, the control unit 411 increments the number of registered imaging apparatuses N, and updates the number of registered imaging apparatuses displayed in the number of registered imaging apparatuses display 902. The processing ends.

The procedure is repeated each time the imaging apparatus registration set button 901 is tapped. If the registration is reset by a separately-prepared reset setting, the control unit 411 resets the number of registered imaging apparatuses N to 0, and resets the information in the display section 903 displaying the installation positions of the imaging apparatuses.

### Imaging Area Setting Method

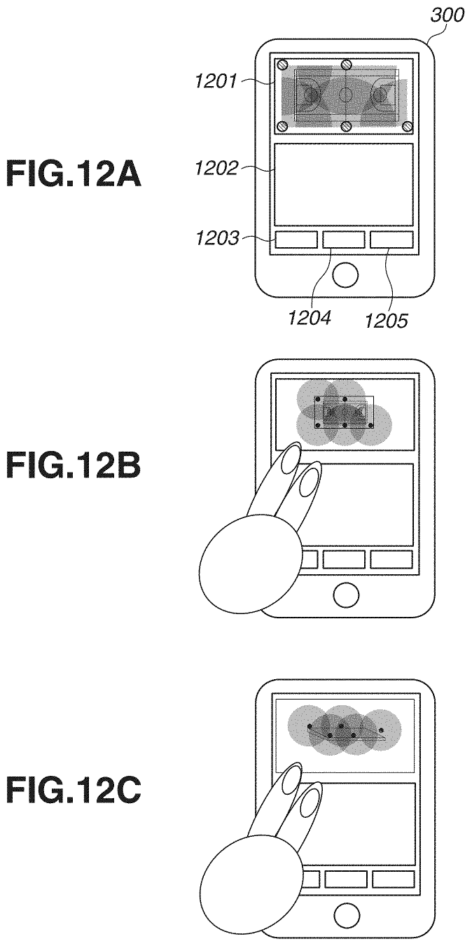

If the screen returns to that of FIG. 8 and the user 700 taps an imaging area setting tab 802, the screen transitions to an imaging area setting screen. FIGS. 12A to 12C illustrate the imaging area setting screen. A display section 1201 displays the installation positions of the imaging apparatuses 101, where the layout of the imaging apparatuses 101 set on the foregoing imaging apparatus layout setting screen is displayed. As illustrated in FIGS. 12A to 12C, the user 700 may paste a picture into the display section 1201 (in the illustrated example, a picture of a basketball court is pasted). A separately-prepared image captured from above may be pasted. An area 1202 displays an actual live video image of an imaging apparatus 101. If the user 700 taps the installation position of an imaging apparatus 101 in the display section 1201, the video image of the specified imaging apparatus 101 can be live displayed in the area 1202. Buttons 1203, 1204, and 1205 are each provided for the purpose of changing mode. The button 1203 is provided as a mode switch for entering an “imaging area check mode” screen. The button 1204 is provided as a mode switch for entering an “overall imaging area setting mode” screen. The button 1205 is provided as a mode switch for entering an “individual imaging area setting mode” screen.

The “imaging area check mode” will initially be described.

### Imaging Area Check Mode

If the button 1203 is tapped, the screen transitions to the “imaging area check mode” screen (FIGS. 12A to 12C).

As described above, the layout of the imaging apparatuses 101 is displayed in the display section 1201. If no imaging area has been set by the user in the “overall imaging area setting mode” or “individual imaging area setting mode” to be described below, the display section 1201 displays all the areas where the imaging apparatuses 101 can capture an image by driving the tilt rotation units 104, the pan rotation units 105, and the zoom units 201. The more areas where a plurality of imaging apparatuses 101 can capture an image overlap, the darker the display color. If areas where a plurality of imaging apparatuses 101 can capture an image do not overlap, the areas are displayed in light color. Based on the maximum focal length of each imaging apparatus 101, up to what distance is treated as the imaging area of the imaging apparatus 101 is determined with the imaging apparatus 101 as an origin. Specifically, the radius from the installation position of an imaging apparatus 101 is determined to satisfy the condition that the imaging magnification at the maximum zoom position is higher than or equal to a predetermined value. Such a display enables the user to check in which area a multiple viewpoint video image can be obtained by a plurality of imaging apparatuses 101 and in which area imaging using a plurality of imaging apparatuses is difficult.

The display section 1201 displaying the installation positions of the imaging apparatuses 101 is capable of zooming in, zooming out, and rotation. The screen display can be zoomed out to observe a wider area by an operation of pinching the display section 1201 on the touch screen with two fingers (pinch-in operation). The screen can be zoomed in to observe the imaging areas more closely by an operation of spreading out the display section 1201 on the touch screen with two fingers (pinch-out operation). FIGS. 12A and 12B illustrate an example of the pinch-in operation. The angle of the screen display can be changed by an operation of sliding two fingers over the display section 1201 on the touch screen. For example, a vertical sliding operation can rotate the screen display with a horizontal axis as the rotation axis. A horizontal sliding operation can rotate the screen display with a vertical axis as the rotation axis (FIG. 12C illustrates an example).

The center position of the screen display can be moved by a sliding operation with a single finger. The live video image of a specified imaging apparatus 101 can be displayed in the area 1202 by tapping the installation location of the imaging apparatus 101.

### Overall Imaging Area Setting Mode

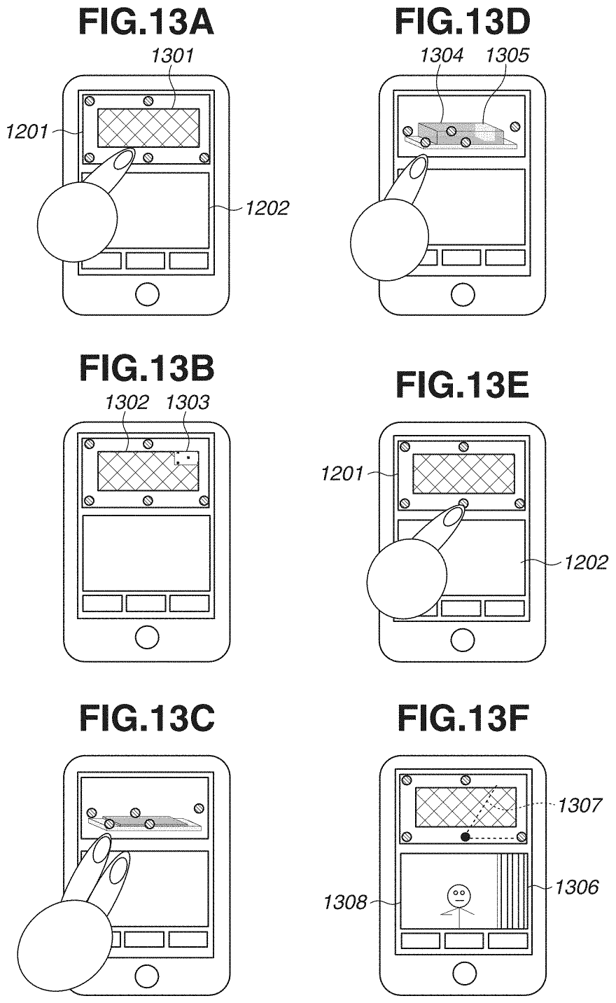

If the button 1204 is tapped, the screen transitions to the “overall imaging area setting mode” screen (FIGS. 13A to 13F).

In the “overall imaging area setting mode”, the user 700 manually operates an area (imaging area) to capture an image on the screen displayed in the display section 1201 displaying the installation positions of the imaging apparatuses 101, so that a user-intended video image is more likely to be captured when the plurality of imaging apparatuses 101 performs automatic framing imaging. The imaging apparatuses 101 are automatically controlled to capture few images in areas not specified as the imaging area here. FIG. 13A illustrates an example where the user 700 specifies an imaging area 1301 in the screen display of the display section 1201 displaying the installation positions of the imaging apparatuses 101.

If the imaging area 1301 is specified by the user 700, an area 1302 and an area 1303 in the specified imaging area 1301 are displayed as respective visually different areas as illustrated in FIG. 13B. An area capable of being comprehensively imaged by the arranged imaging apparatuses 101 is displayed as with the area 1302. An area determined to not be capable of being comprehensively imaged is displayed as with the area 1303. Areas far from the arranged imaging apparatuses 101 and non-overlapping areas where two or more imaging apparatuses 101 are unable to capture an image as illustrated in FIGS. 12A to 12C are determined to not be capable of being comprehensively imaged.

As in the method described with reference to FIGS. 12A to 12C, the display section 1201 displaying the installation positions of the imaging apparatuses 101 is capable of zooming in, zooming out, and rotation. The screen display can be zoomed out to observe a wider area by an operation of pinching the display section 1201 on the touch screen with two fingers (pinch-in operation). The screen display can be zoomed in to observe the imaging area 1301 more closely by an operation of spreading out the display section 1201 on the touch screen with two fingers (pinch-out operation). The angle of the screen display can be changed by an operation of sliding two fingers over the display section 1201 on the touch screen in the same direction. For example, a vertical sliding operation can rotate the screen display with a horizontal axis as the rotation axis. A horizontal sliding operation can rotate the screen display with a vertical axis as the rotation axis (FIG. 13C illustrates an example). With the direction of gravity as the Z-axis direction, an imaging area can be specified within the range of the X- and Y-axes and whether an area is capable of being comprehensively imaged can be checked in a view displayed in the Z-axis direction as illustrated in FIGS. 13A and 13B. In addition, an imaging range in the Z-axis direction can also be specified. FIG. 13D illustrates an example where the screen display is rotated to a screen angle at which the Z-axis direction can be specified, and in which state the user 700 specifies the imaging area in the Z-axis direction. An area capable of being comprehensively imaged by the arranged imaging apparatuses 101 is displayed as with an area 1304. An area determined to not be capable of being comprehensively imaged is displayed as with an area 1305.

The area 1202 displays the live video image of a specified imaging apparatus 101. If the user 700 taps the installation position of an imaging apparatus 101 in the display section 1201 as in FIG. 13E, the live video image of the specified imaging apparatus 101 is displayed in the area 1202. FIG. 13F illustrates a display example. The display section 1201 displays the specified imaging apparatus 101 in different color, shape, or size so that which imaging apparatus 101 is specified can be observed. An angle of view range display 1307 indicating the current display angle of view of the specified imaging apparatus 101 is also displayed at the same time. The live video image in the area 1202 is also configured to indicate the range of the imaging area 1301 specified manually the user 700 (for example, an area 1308 is an area specified as the imaging area; an area 1306 not specified as the imaging area is displayed in gray).

In such a manner, the user can specify an imaging area with a simple operation, and can visualize an area capable of being comprehensively imaged and an area not capable of being comprehensively imaged. In addition, the user can observe the inside and outside of the range of the specified area while monitoring the actual live video image of an imaging apparatus 101.

### Individual Imaging Area Setting Mode

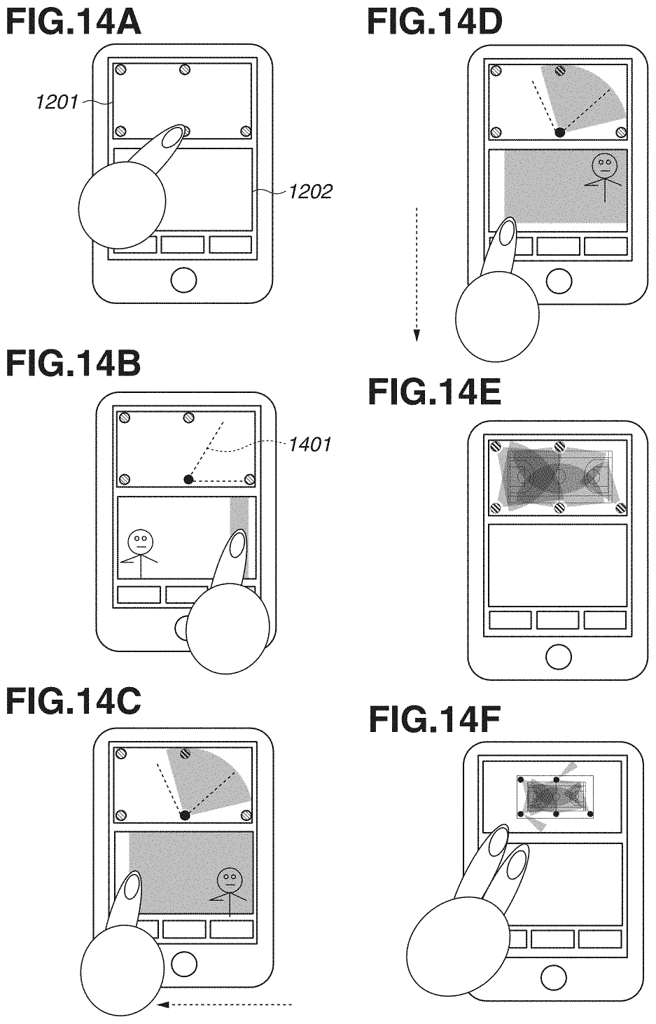

If the button 1205 is tapped, the screen transitions to the “individual imaging area setting mode” screen (FIGS. 14A to 14F).

In the “individual imaging area setting mode”, the imaging areas of the respective imaging apparatuses 101 can be specified in detail. If the user 700 taps the installation position of an imaging apparatus 101 of which the user wants to set the imaging area on the screen displayed in the display section 1201 displaying the installation positions of the imaging apparatuses 101 as illustrated in FIG. 14A, the live video image of the specified imaging apparatus 101 is displayed in the area 1202. FIG. 14B illustrates a display example. The display section 1201 displays the specified imaging apparatus 101 in different color, shape, or size so that which imaging apparatus 101 is specified can be visually observed. An angle of view range display 1401 indicating the current display angle of view of the specified imaging apparatus 101 is also displayed at the same time. The user 700 specifies an imaging area within the display screen by making a sliding operation on the area 1202 displaying the live video image on the touch screen with a single finger. The user 700 can specify the range of the imaging area by making a sliding operation of horizontally sliding the finger over the screen, such as a movement from the point in FIG. 14B to the point in FIG. 14C. If the sliding operation reaches near the screen end, the specified imaging apparatus 101 is driven to pan in the horizontal (pan) direction. The user 700 can thereby specify the imaging area while changing the optical axis of the imaging apparatus 101. A sliding operation in the vertical (tilt) direction can also be made in a similar manner. The user 700 can specify the range of the imaging area by making a sliding operation of vertically sliding the finger over the screen such as a movement from the point in FIG. 14C to the point in FIG. 14D. If the sliding operation reaches near the screen end, the specified imaging apparatus 101 is driven to tilt in the vertical (tilt) direction. This facilitates specifying the imaging area by changing the optical axis. The user 700 may want to change the optical axis of the imaging apparatus 101 by pan and tilt driving without specifying an imaging area. In such a case, the screen display can be moved in the vertical and horizontal (tilt and pan) directions without specifying an imaging area, for example, by a sliding operation with two fingers. An operation of pinching the area 1202 on the touch screen with two fingers (pinch-in operation) increases the angle of view by zoom driving, so that the screen display can be zoomed out to allow the user 700 to observe a wider area. An operation of spreading out the area 1202 on the touch screen with two fingers (pinch-out operation) reduces the angle of view by zoom driving, so that the screen display can be zoomed in to allow the user 700 to observe the imaging area more closely.

An area where the imaging apparatus 101 performs automatic zoom driving may be specified by the user 700.

If the user 700 wants to cancel a specified imaging area, for example, the user 700 taps the specified imaging area twice to display a “whether to cancel” message on the screen. If cancel OK is specified, the specified imaging area is cancelled. Alternatively, “specify” and “cancel” touch buttons may be provided on the touch screen, and the user 700 may tap the “cancel” button to cancel the imaging area specified by the sliding operation on the area 1202.

By using the foregoing method, the imaging areas of the respective imaging apparatuses 101 can be specified one by one. If the button 1203 is tapped after the imaging areas of the respective imaging apparatuses 101 are specified on the “individual imaging area setting mode” screen, the screen transitions to the “imaging area check mode” screen (described with reference to FIGS. 12A to 12C). FIG. 14E illustrates a display example of the imaging areas individually specified by the method described in conjunction with FIGS. 14A to 14D. Based on the specified imaging areas of the respective imaging apparatuses 101, whether each area is comprehensively imaged can be visually observed in terms of the depth of color (the more areas where a plurality of imaging apparatuses 101 can capture an image overlap, the darker the display color. If areas where a plurality of imaging apparatuses 101 can capture an image do not overlap, the areas are displayed in light color).

FIGS. 14E and 14F illustrate an example of a pinch-in operation. The screen display is zoomed out by the pinch-in operation, and the imaging areas can be observed on a screen display where a wide area can be observed.

In such a manner, the user 700 can individually specify the imaging areas of the respective imaging apparatuses 101 with simple operations, and can visualize areas capable of being comprehensively imaged and areas not capable of being comprehensively imaged.

The user 700 can easily specify imaging areas using a plurality of imaging apparatuses 101 through the foregoing method. Cooperative framing adjustment in the specified imaging areas by the plurality of imaging apparatuses 101 and automatic imaging around the specified imaging areas by the plurality of imaging apparatuses 101 are supported.

### Remote Control Setting Mode

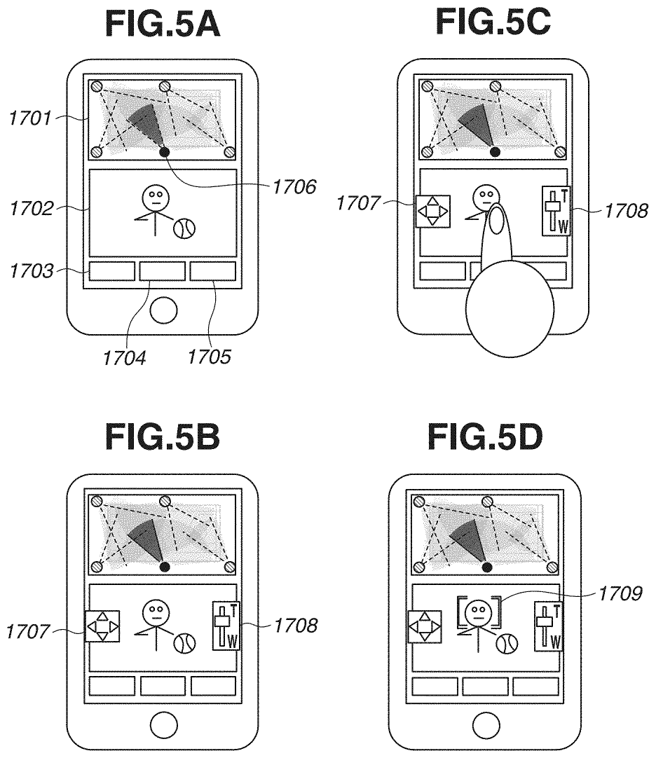

If the screen returns to that of FIG. 8 and the user 700 taps a remote control tab 803, the screen transitions to a remote control screen. FIG. 5A illustrates the remote control screen. A display section 1701 displays the installation positions of the imaging apparatuses 101. The display section 1701 displays the layout of the imaging apparatuses 101 set on the foregoing imaging apparatus layout setting screen and the imaging areas set on the imaging area setting mode screen in an identifiable manner. The display section 1701 can also visualize in which direction each imaging apparatus 101 is currently facing and what angle of view range each imaging apparatus 101 has. If the angle of view or the direction of the optical axis of an imaging apparatus 101 is automatically or manually changed, the directional display also changes at the same time. An area 1702 displays the actual live video image of an imaging apparatus 101. If the user 700 taps the installation position of an imaging apparatus 101 on the display section 1701, the video image of the specified imaging apparatus 101 can be live displayed in the area 1702. Which imaging apparatus 101 is currently under live display can be seen in the display section 1701. The display section 1701 displays the installation position of the imaging apparatus 101 in different color, shape, or size like an installation position 1706. An imaging button 1704 can be used to give instructions to start capturing a moving image, capture a still image, or start automatic imaging. An imaging apparatus setting button 1705 can be used to change the settings of the imaging apparatus 101. If the imaging apparatus setting button 1705 is tapped, an imaging apparatus setting menu is displayed. For example, resolution, frame rate, and white balance settings can be manually operated from the imaging apparatus setting menu.

If the user 700 wants to remotely operate the imaging apparatus 101, the user 700 taps a remote control operation button 1703 to enter a remote operation screen. FIG. 5B illustrates the remote operation screen. The remote operation screen displays an operation section 1707 capable of pan and tilt operations and an operation section 1708 capable of zoom operations. The user 700 drives the specified imaging apparatus 101 to tilt by touching at up and down icons in the operation section 1707 and to pan by touching at left and right icons. The optical axis of the imaging apparatus 101 can thereby be changed. Moreover, the imaging apparatus 101 is driven to zoom in a direction of narrowing the angle of view (to a telescopic side) by an upward sliding operation on a switch icon in the operation section 1708, and to zoom in a direction of widening the angle of view (to a wide side) by a downward sliding operation on the switch icon. The angle of view can be thus changed.

In the foregoing example, the operation sections 1707 and 1708 are described to be displayed. However, the imaging apparatus 101 may be driven to zoom in and out by making pinch-out and pinch-in operations within the area 1702 on the touch screen, and driven to pan and tilt by making a sliding operation, without displaying the operation sections 1707 and 1708.

If the user 700 wants to automatically drive the imaging apparatus 101 to pan, tilt, and zoom so that a specified object is kept positioned at a predetermined position on the screen (for example, near the screen center), the user 700 may specify the object by a touch operation as illustrated in FIG. 5C. If an object is specified by a touch operation, the imaging apparatus 101 controls automatic object tracking and displays an object frame 1709 so that the currently-tracked object is visually identifiable as illustrated in FIG. 5D. The object tracking can be continued until cancelled. For example, a cancellation button may be displayed and the object tracking may be cancelled if the cancellation button is touched. Alternatively, the object tracking may be cancelled if the optical axis or the angle of view of the imaging apparatus 101 is manually changed by using the operation section 1707 or 1708.

During an automatic framing imaging operation, a specified imaging area can become unable to be imaged because of a dead angle behind an obstacle (for example, a person can come and remain in front of the imaging apparatus 101). A warning display in such a case will now be described.

Since the imaging areas are specified as described in conjunction with FIGS. 9 to 14F, a dead angle is determined to occur if a foreground object is detected closer to an imaging apparatus 101 than the range set as its imaging area and the object occupies an area greater than a predetermined value in the imaging range. In such a case, the application in the smart device 301 displays a warning. For example, the smart device 301 is notified of the imaging apparatus 101 in which the dead angle occurs. The application informs the user of the warning by blinking the icon of the imaging apparatus 101 in the display section 1701 or providing an error display. The distance may be measured by any method, including a focus-based method and one using an external sensor. Alternatively, suppose that a plurality of imaging apparatuses 101 is tracking the same object and capturing an image thereof at the same time, or capturing an image of the same imaging area. In such a case, a warning may be displayed if image information of one imaging apparatus 101 does not coincide with that of another. Examples of the image information include object detection information and feature information such as hue and saturation in the images.

### Automatic Framing/Imaging Processing

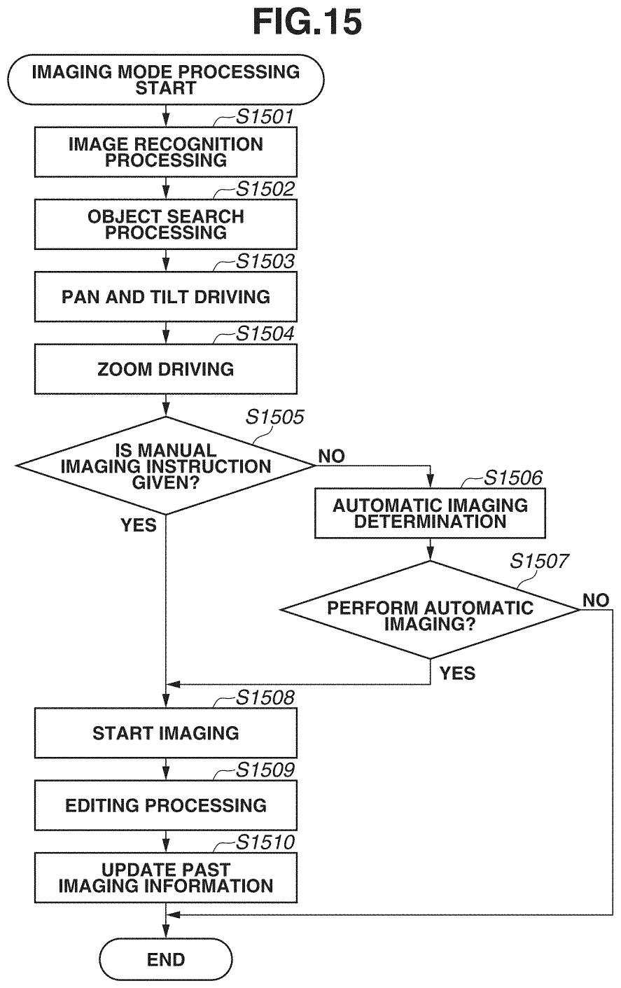

Next, details of automatic imaging processing will be described. If an instruction to start imaging control is given from the button 1704, an imaging operation is started. Imaging mode processing will be described with reference to FIG. 15.

In step S1501, the image processing unit 207 generates an image intended for object detection by performing image processing on the signal captured by the imaging unit 206. The first control unit 223 performs object detection, such as human detection and general object detection based on the generated image.

In the case of human detection, the first control unit 223 detects the object's face or human body. For face detection processing, patterns for determining a human face are provided in advance, and a region matching a pattern in the captured image can be detected as a human face image. The first control unit 223 also calculates a degree of reliability indicating the likelihood of the object being a face at the same time. For example, the degree of reliability is calculated based on the size of the face region in the image and the degree of matching with the pattern. Similarly, in the case of general object detection, the first control unit 223 can recognize a general object matching a previously registered pattern. Alternatively, a characteristic object can be extracted through a method using hue and saturation histograms of the captured image. Here, distributions derived from the hue or saturation histograms of an object image captured within the imaging angle of view are divided into a plurality of intervals. Processing for classifying the captured image interval by interval is then performed.

For example, the first control unit 223 generates histograms of a plurality of color components of the captured image. The first control unit 223 divides the histograms into unimodal intervals, classifies images captured in regions belonging to the combination of the same intervals, and recognizes the object image regions. The first control unit 223 calculates evaluation values for the respective object image regions recognized, and thus, the object image region having the highest evaluation value can be determined as a main object region. Convolutional neural networks (CNNs) may be trained to detect intended objects in advance, and the CNNs may be applied to the face detection and the general object detection. By using such a method, pieces of object information can be obtained from the captured image.

In step S1502, the first control unit 223 performs object search processing. The object search processing includes the following processes:

(1) Area division

(2) Area-by-area calculation of importance levels

(3) Determination of the area to be searched

The processes will be described below in order.

### (1) Area Division

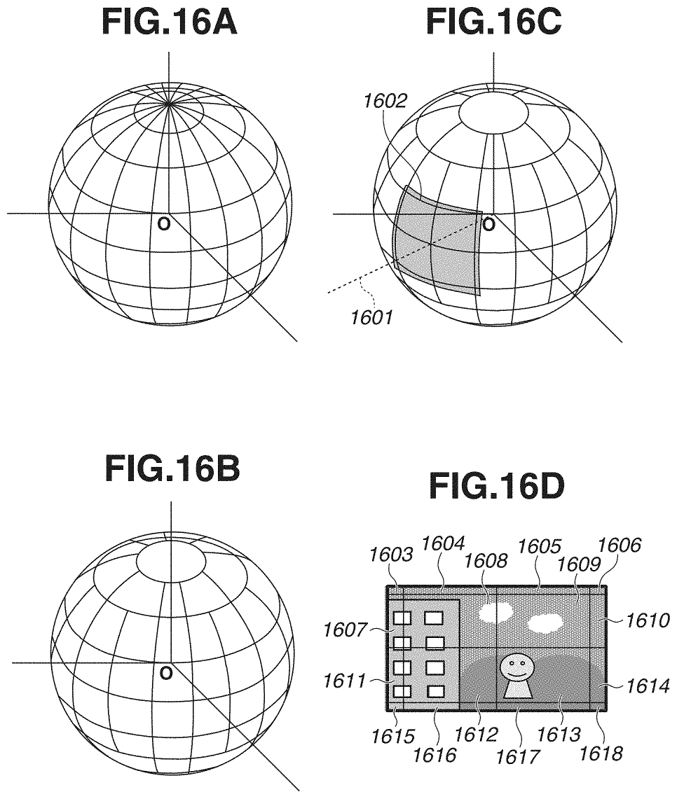

The area division will be described with reference to FIGS. 16A to 16D.

The first control unit 223 performs area division all over with the position of the imaging apparatus 101 at the center (with the position of the imaging apparatus 101 as an origin O) as illustrated in FIG. 16A. In the example of FIG. 16A, the areas are divided in units of 22.5° in both the tilt and pan directions. If the entire area is divided as illustrated in FIG. 16A, the horizontal circumference becomes shorter and the areas smaller as the angle in the tilt direction of the imaging apparatus 101 gets farther away from 0°.

As illustrated in FIG. 16B, the areas at a tilt angle of 45° or more are therefore horizontally divided in units greater than 22.5°.

FIGS. 16C and 16D illustrate examples of area division within the imaging angle of view. An axis 1601 represents the direction of the imaging apparatus 101 when initialized. The area division is performed with the directional angle as a reference position. An angle of view area 1602 represents the image being captured. FIG. 16D illustrates an example of the captured image here. The image captured within the angle of view is divided into areas 1603 to 1618 of FIG. 16D based on the area division.

### (2) Area-by-Area Calculation of Importance Levels

The first control unit 223 calculates importance levels indicating the order of priority in a search. The first control unit 223 calculates the importance levels of each of the areas divided as described above based on the state of an object or objects in the area and the state of the scene of the area. The importance level based on the state of an object or objects is calculated, for example, based on the number of human figures in the area, face sizes and face directions of the human figures, the probability of face detection, facial expressions of the human figures, and personal authentication results of the human figures. The importance level based on the state of the scene is calculated, for example, based on a general object recognition result, a scene discrimination result (such as blue sky, backlight, and twilight view), the level of sound from the direction of the area, a voice recognition result, and motion detection information within the area.

If the imaging areas are specified by the user 700 by using the method described in conjunction with FIGS. 12A to 14F, the importance levels of areas located in unspecified imaging areas are fixed to a minimum value so that the imaging apparatuses 101 make searching and framing operations within the respective specified imaging areas. This precludes a search of those areas.

If the importance levels of the areas remain unchanged under the foregoing conditions alone, the area of the highest importance level remains the same and thus the area to be searched remains unchanged unless a change occurs in the respective areas. To avoid this, the first control unit 223 changes the importance levels based on past imaging information. Specifically, the importance level of an area continuously specified as a search area for a predetermined period of time may be lowered. The importance level of an area where an image is captured in step S1508 to be described below may be lowered for a predetermined period of time. The first control unit 223 does not change but maintains the importance levels of the areas not specified as imaging areas by the user at the minimum value.

### (3) Determination of Area to be Searched

With the importance levels of the areas calculated as described above, the first control unit 223 determines the area having the highest importance level to be the area to be searched. The first control unit 223 then calculates pan and tilt search target angles for capturing the search target area within the angle of view.

In step S1503, the first control unit 223 performs pan and tilt driving. The first control unit 223 calculates the amounts of pan and tilt driving by adding driving angles obtained by control sampling based on the pan and tile search target angles. The lens barrel rotation driving unit 205 controls driving of the tilt rotation unit 104 and the pan rotation unit 105.

In step S1504, the zoom driving control unit 202 controls the zoom unit 201 for zoom driving. Specifically, the zoom driving control unit 202 drives the zoom unit 201 to zoom based on the state of an object to be searched for determined in step S1502. For example, if the object to be searched for is a human face, too small a face on the image can fall below a minimum detectable size and be lost track of due to a detection failure. In such a case, the zoom driving control unit 202 controls the zoom unit 201 so that the zoom unit 201 zooms in to the telescopic side to increase the size of the face on the image. On the other hand, if the face on the image is too large, the object can easily go out of the angle of view due to movement of the object or the imaging apparatus 101 itself. In such a case, the zoom driving control unit 202 controls the zoom unit 201 so that the zoom unit 201 zooms out to the wide side to reduce the size of the face on the image. Such zoom control can maintain a state suitable to keep track of the object.

While the object search in steps S1502 to S1504 is described to be performed by pan, tilt, and zoom driving, an imaging system that captures images in all directions at a time by using a plurality of wide angle lenses may be used for object search. In the case of an omnidirectional imaging apparatus, performing image processing, such as object detection, using all the captured signals as an input image involves an enormous amount of processing. In such a case, the first control unit 223 crops a part of the image and performs object search processing within the cropped image. The first control unit 223 calculates the importance levels of respective areas in a manner similar to the foregoing method, changes the cropping position based on the importance levels, and makes an automatic imaging determination to be described below. Such a configuration can reduce the power consumption of the image processing and enables fast object search.

In step S1505, the first control unit 223 determines whether a manual imaging instruction is given. If the imaging instruction is given (YES in step S1505), the processing proceeds to step S1506. The manual imaging instruction can be given by pressing a shutter button, by lightly tapping the casing of the imaging apparatus 101 with a finger, by voice command input, or as an instruction from an external device. The method for giving an imaging instruction based on a tap operation uses a series of high-frequency accelerations detected in a short time by the apparatus vibration detection unit 209 as an imaging trigger when the user taps the casing of the imaging apparatus 101. The method for giving an imaging instruction by voice command input uses a voice recognized by the audio processing unit 214 as an imaging trigger when the user utters a predetermined cue phrase for imaging instruction (such as “take a picture”). The method for giving an imaging instruction as an instruction from an external device uses as a trigger a shutter instruction signal that is transmitted from, for example, a smart phone connected to the imaging apparatus 101 over wireless communication via a dedicated application.

In step S1506, the first control unit 223 makes an automatic imaging determination. The automatic imaging determination determines whether to perform automatic imaging.

### Determination About Whether to Perform Automatic Imaging

Whether to perform automatic imaging is determined based on the following two determinations. One is a determination based on the area-specific importance levels obtained in step S1502. If the importance levels exceed a predetermined value, the first control unit 223 determines to perform automatic imaging. The other is a determination based on a neural network. The neural network is used to estimate an output value from input values. A neural network trained with input values and exemplary output values for the input values in advance can estimate an output value following the trained examples from new input values. The training method will be described below. In the determination based on the neural network, objects captured in the current angle of view and feature amounts based on the states of the scene and the imaging apparatus 101 are input to neurons in an input layer. A value output from an output layer through calculations based on a multilayer perceptron forward propagation method is thereby obtained. If the output value is greater than or equal to a threshold, automatic imaging is determined to be performed. Examples of object features include the current zoom magnification, a general object recognition result in the current angle of view, a face detection result, the number of faces captured in the current angle of view, a degree of smiling and a degree of eye closure of the face or faces, face angles, face authentication identification (ID) numbers, and the line of sight angle of an object person. In addition, a scene discrimination result, the elapsed time from the previous imaging, the current time, GPS position information, the amount of change from the previous imaging position, the current sound level, the person uttering a voice, and the presence or absence of handclapping and cheers may be used. Vibration information (acceleration information or the state of the imaging apparatus) and environmental information (temperature, atmospheric pressure, illuminance, humidity, and the amount of ultraviolet rays) may also be used. The first control unit 223 converts such features into numerical values in a predetermined range, and inputs the numerical values to the respective neurons of the input layer as feature amounts. As many neurons of the input layer as the number of feature amounts to be used are thus used.

The training processing unit 219 can change the connection weights between the neurons to change the output value, and thus a result of the neural network-based determination can be adapted to the training result.

### Determination of Imaging Method

In determining an imaging method, the first control unit 223 determines which imaging method to perform, still image capturing or moving image capturing, based on the state of an object or objects nearby detected in step S1501. For example, if the object(s) (person(s)) is/are standing still, the first control unit 223 determines to perform still image capturing. If the object(s) is/are moving, the first control unit 223 determines to perform moving image capturing or continuous shooting. A neural network-based determination may be made. The user can manually change the settings of the imaging apparatus 101 by using a dedicated application. The imaging apparatus 101 can be set to capture only still images, only moving images, or capture and save both.

In step S1507, if automatic imaging is determined to be performed by the automatic imaging determination in step S1506 (YES in step S1507), the processing proceeds to step S1508. If not (NO in step S1507), the imaging mode processing ends.

In step S1508, the imaging apparatus 101 starts imaging. Here, the imaging apparatus 101 starts to capture an image through the imaging method determined in step S1506. In the meantime, the focus driving control unit 204 performs automatic focus control. The imaging apparatus 101 also performs exposure control by using a not-illustrated aperture control unit, sensor gain control unit, and shutter control unit so that the object(s) has/have appropriate brightness. After the imaging, the image processing unit 207 performs various types of conventional image processing, such as automatic white balance processing, noise reduction processing, and gamma correction processing, and generates an image.

In the case of moving image capturing, the imaging apparatus 101 captures the moving image while performing framing operations by pan, tilt, and zoom driving based on the object detection as described in steps S1501 to S1504 even during imaging and recording. As in the foregoing method, a search based on the area-by-area importance levels may be performed. A large-scale search operation may be disabled during moving image capturing. A specific object may be registered, and the imaging apparatus 101 may capture a moving image while keeping track of the registered object within a specified imaging area by pan, tilt, and zoom driving so that the registered object is kept positioned near the screen center.

In step S1509, the first control unit 223 performs editing processing for processing the image generated in step S1508 or adding the image to a moving image. Specific examples of the image processing include trimming processing based on a human face or an in-focus position, image rotation processing, and application of effects, such as a high dynamic range (HDR) effect, a blurring effect, and a color conversion filter effect. These processes may be combined to generate a plurality of processed images from the image generated in step S1508, and the processed images may be stored separate from the image generated in step S1508. In the case of moving image processing, the first control unit 223 may apply special effect processing such as sliding, zooming, and fading to the captured moving image or still image, and add the resulting image to an already-generated edited moving image.

In step S1510, the first control unit 223 updates the past imaging information. Specifically, the first control unit 223 increments the following counts corresponding to the image captured this time by one: the numbers of captured images in the respective areas described in step S1506, the numbers of captured images of respective authenticated and registered persons, the numbers of captured images of respective objects recognized by general object recognition, and the numbers of captured images of respective scenes discriminated through scene discrimination.

By using the foregoing method, the user 700 can easily specify imaging areas using a plurality of imaging apparatuses 101. Cooperative framing adjustment in the specified imaging areas by the plurality of imaging apparatuses 101 and automatic imaging around the specified imaging areas by the plurality of imaging apparatuses 101 are thus supported.

By using the foregoing method, the user 700 can specify imaging areas with a simple operation. The plurality of imaging apparatuses 101 then cooperatively makes a framing adjustment in the specified imaging areas and performs automatic imaging around the specified imaging areas, so that automatic imaging highly likely to capture a user-desired video image can be implemented.

The present exemplary embodiment has been described by using an example where a plurality of imaging apparatuses 101 having the pan, tilt, and zoom configurations illustrated in FIGS. 1A and 1B is used. All the plurality of imaging apparatuses 101 used may have the pan, tilt, and zoom configurations illustrated in FIGS. 1A and 1B. Imaging apparatuses having the zoom configuration without a pan or tilt configuration may be used. Imaging apparatuses having the pan and tilt configurations without a zoom configuration may be used. Some of the imaging apparatuses 101 may have a fixed focal length without a zoom, pan, or tilt configuration. An omnidirectional imaging apparatus that includes a plurality of image sensors and a wide angle optical system and captures images in all directions at a time may be used.

### Other Embodiments

An exemplary embodiment of the present invention can be implemented by processing for supplying a program for implementing one or more of the functions of the foregoing exemplary embodiment to a system or an apparatus via a network or a recording medium, and reading and executing the program by one or more processors in a computer of the system or apparatus. A circuit for implementing one or more functions (for example, application specific integrated circuit (ASIC)) may be used for implementation.

An exemplary embodiment of the present invention is not limited to imaging by a digital camera or a digital video camera, and can also be implemented on an information processing apparatus that communicates with imaging apparatuses, such as a surveillance camera, a web camera, and a mobile phone. The information processing apparatus is not limited to a mobile phone such as a smartphone, and may be a tablet computer.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to an exemplary embodiment of the present invention, an information processing apparatus that facilitates checking an imaging area in operating a plurality of imaging apparatuses in a cooperative manner and a control method thereof can be provided.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

The present invention is not limited to the foregoing exemplary embodiments, and various changes and modifications can be made without departing from the spirit and scope of the present invention. The following claims are therefore attached to make public the scope of the present invention.

1. An information processing apparatus comprising:
a storage unit configured to store position information about a position of each of a plurality of imaging apparatuses;
an obtaining unit configured to obtain azimuths and angles of the plurality of imaging apparatuses;
a setting unit configured to set an imaging area of the plurality of imaging apparatuses; and
a notification unit configured to make a notification of an area to be comprehensively imaged and an area to not be comprehensively imaged based on the position information stored in the storage unit, information obtained by the obtaining unit, and information about the imaging area set by the setting unit.

2. The information processing apparatus according to claim 1, wherein the setting unit is configured to set an imaging area common among the plurality of imaging apparatuses.

3. The information processing apparatus according to claim 1, wherein the setting unit is configured to set an individual imaging area of each of the plurality of imaging apparatuses.

4. The information processing apparatus according to claim 1, wherein the plurality of imaging apparatuses each includes an imaging lens and an image sensor, and is configured to perform automatic imaging processing based on the imaging area set by the setting unit.

5. The information processing apparatus according to claim 4, wherein the plurality of imaging apparatuses each includes a rotation mechanism configured to drive a casing including the imaging lens and the image sensor to rotate about at least one or more axial directions, and the plurality of imaging apparatuses is each configured to perform processing of searching for a specific object by rotating the rotation mechanism.

6. The information processing apparatus according to claim 4, wherein the automatic imaging processing includes processing of detecting an imaging trigger.

7. The information processing apparatus according to claim 5, wherein the plurality of imaging apparatuses is each configured to perform the processing of searching for the specific object by controlling zoom driving of a zoom lens included in the imaging lens.

8. The information processing apparatus according to claim 5, wherein the plurality of imaging apparatuses is each configured to perform the processing of searching for the specific object by cropping part of a captured image.

9. The information processing apparatus according to claim 1, further comprising a detection unit configured to detect a dead angle in the imaging area set by the setting unit,
wherein the notification unit is configured to further make a notification of a detection result of the detection unit.

10. A control system comprising:
a plurality of imaging apparatuses;
a storage unit configured to store position information about a position of each of the plurality of imaging apparatuses;
an obtaining unit configured to obtain azimuths and angles of the plurality of imaging apparatuses;
a setting unit configured to set an imaging area of the plurality of imaging apparatuses; and
a notification unit configured to make a notification of an area to be comprehensively imaged and an area to not be comprehensively imaged based on the position information stored in the storage unit, information obtained by the obtaining unit, and information about the imaging area set by the setting unit,
wherein the plurality of imaging apparatuses is configured to perform automatic imaging processing based on the imaging area set by the setting unit.

11. A method for controlling an information processing apparatus, comprising:
storing position information about a position of a plurality of imaging apparatuses;
obtaining azimuths and angles of the plurality of imaging apparatuses;
setting an imaging area of the plurality of imaging apparatuses; and
making a notification of an area to be comprehensively imaged and an area to not be comprehensively imaged based on the stored position information, information about the obtained azimuths and angles, and information about the set imaging area.

12. A computer-readable storage medium storing a program for causing a computer to execute the method according to claim 11.
